(19) United States
(12) Patent Application Publication
(10) Pub. No.: US 2014/0033726 A1
(43) Pub. Date: Feb. 6, 2014

(54) LINER COOLING ASSEMBLY FOR A GAS TURBINE SYSTEM

(71) Applicants: Wei Chen, Greer, SC (US); Jerome David Brown, Simpsonville, SC (US)

(72) Inventors: Wei Chen, Greer, SC (US); Jerome David Brown, Simpsonville, SC (US)

(21) Appl. No.: 13/567,826

(22) Filed: Aug. 6, 2012

(51) Int. Cl. F23R 3/42; F02C 7/12

(52) U.S. Cl. 60/752

(57) ABSTRACT

A liner cooling assembly for a gas turbine system includes a liner having an outer surface and an inner surface, the inner surface defining an interior region. Also included is a sleeve disposed radially outwardly of the outer surface of the liner, the sleeve and the outer surface of the liner defining a channel configured to receive a cooling flow. Further included is a cooling jacket extending circumferentially around at least a portion of the outer surface of the liner and disposed between the liner and the sleeve, wherein the cooling jacket comprises at least one support operably coupled to the cooling jacket and the outer surface of the liner.

### BACKGROUND OF THE INVENTION

The subject matter disclosed herein relates to gas turbine systems, and more particularly to a liner cooling assembly for such gas turbine systems.

A combustor section of a gas turbine system typically includes a combustor chamber disposed relatively adjacent a transition piece, where a hot gas passes from the combustor chamber through the transition piece to a turbine section. At least a portion of the combustor chamber is often surrounded by a flow sleeve, while at least a portion of the transition piece is surrounded by an impingement sleeve. The flow sleeve typically includes a plurality of apertures for providing impingement cooling for portions of a liner of the combustor. An additional airflow passes from a region defined by the impingement sleeve and the transition piece to a region defined by the flow sleeve and the combustor liner. The impingement cooling of the liner of the combustor is achieved by cooling jets that are pushed onto the liner in a direction relatively perpendicular to the additional airflow flowing from the region proximate the impingement sleeve to the region proximate the flow sleeve. The additional airflow, perpendicular to the impingement jet is one disruption, among other inefficiencies, resulting in a reduced cooling efficiency of the combustor liner. Conventionally, it is called cross flow. In general, the cooling air is directly used for the combustion air. Otherwise, a much more complex system has to be developed to deliver and discharge the spent cooling air. An associated expense of using combustion air for cooling is the loss of kinetic energy, which is commonly referred to as pressure loss. Reduction of cooling air immediately results in the benefits of lower pressure loss, which will produce higher overall gas turbine efficiency and cost savings. Operation capability of a large scale gas turbine is defined by emissions and thermo-acoustic response of a combustor. Control of cooling air will reduce air temperature variation that limits operability.

### BRIEF DESCRIPTION OF THE INVENTION

According to one aspect of the invention, a liner cooling assembly for a gas turbine system includes a liner having an outer surface and an inner surface, the inner surface defining an interior region. Also included is a sleeve disposed radially outwardly of the outer surface of the liner, the sleeve and the outer surface of the liner defining a channel configured to receive a cooling flow. Further included is a cooling jacket extending circumferentially around at least a portion of the outer surface of the liner and disposed between the liner and the sleeve, wherein the cooling jacket comprises at least one support operably coupled to the cooling jacket and the outer surface of the liner.

According to another aspect of the invention, a combustor liner cooling assembly for a gas turbine system includes a combustor liner defining a combustor chamber. Also included is a flow sleeve surrounding at least a portion of the combustor liner, the flow sleeve and the combustor liner defining a channel configured to receive a cooling flow. Further included is a cooling jacket surrounding at least a portion of the combustor liner and disposed between the combustor liner and the flow sleeve, wherein the cooling jacket comprises at least one support extending radially inwardly from the cooling jacket toward the combustor liner.

According to yet another aspect of the invention, a combustor liner cooling assembly for a gas turbine system includes a combustor liner defining a combustor chamber. Also included is a flow sleeve surrounding at least a portion of the combustor liner, the flow sleeve and the combustor liner defining a channel configured to receive a cooling flow. Further included is a cooling jacket integrally formed with the combustor liner, wherein the cooling jacket includes a body portion disposed radially outwardly of the combustor liner. The cooling jacket also includes a plurality of support members fixedly connected to an inner surface of the body portion and an outer surface of the combustor liner. The cooling jacket further includes a plurality of apertures extending through the body portion of the cooling jacket.

These and other advantages and features will become more apparent from the following description taken in conjunction with the drawings.

### BRIEF DESCRIPTION OF THE DRAWING

The subject matter, which is regarded as the invention, is particularly pointed out and distinctly claimed in the claims at the conclusion of the specification. The foregoing and other features and advantages of the invention are apparent from the following detailed description taken in conjunction with the accompanying drawings in which:

FIG. 1 is a partial, schematic illustration of a combustor section of a gas turbine system;

FIG. 2 is an enlarged view of section II of FIG. 1, illustrating a liner cooling assembly;

FIG. 3 is an enlarged, schematic illustration of section III of FIG. 2, illustrating a support of the cooling assembly;

FIG. 4 is a schematic cross-sectional view taken along lines IV-IV of FIG. 2 of a portion of the cooling assembly having a plurality of apertures disposed therein; and

FIG. 5 is a cross-sectional view taken along lines V-V of FIG. 4.

The detailed description explains embodiments of the invention, together with advantages and features, by way of example with reference to the drawings.

### DETAILED DESCRIPTION OF THE INVENTION

The terms “axial” and “axially” as used in this application refer to directions and orientations extending substantially parallel to a center longitudinal axis of a turbine system. The terms “radial” and “radially” as used in this application refer to directions and orientations extending substantially orthogonally to the center longitudinal axis of the turbine system. The terms “upstream” and “downstream” as used in this application refer to directions and orientations relative to an axial flow direction with respect to the center longitudinal axis of the turbine system.

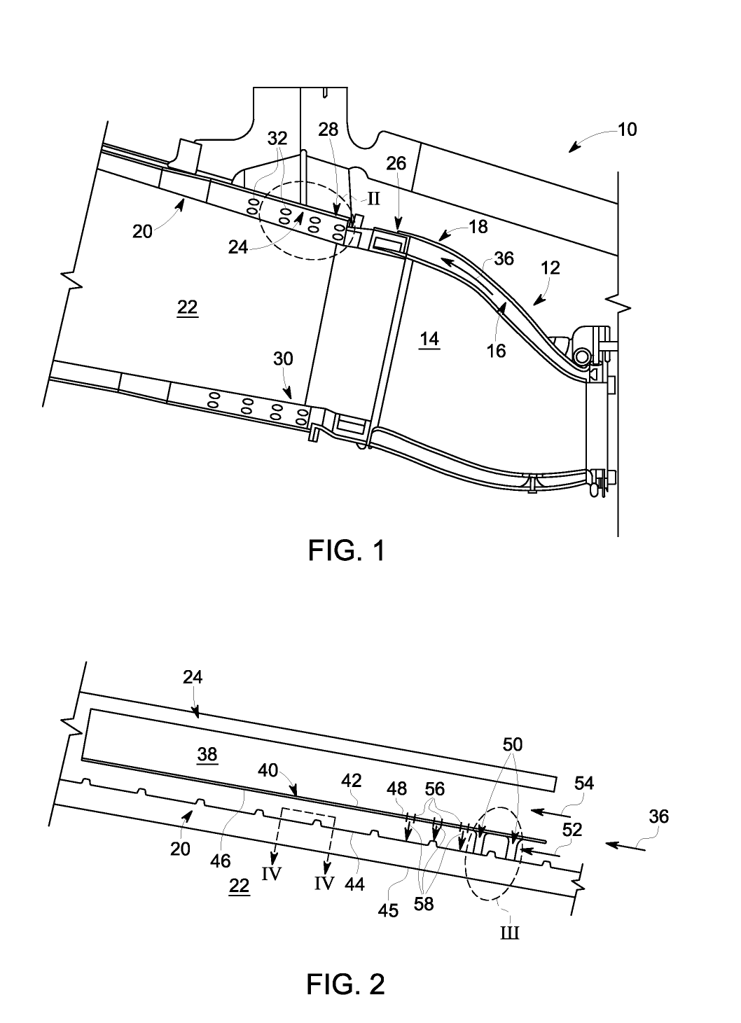

With reference to FIG. 1, a partial schematic illustrates a combustor section of a gas turbine system and is referred to generally with numeral 10. The combustor section 10 includes a transition piece 12 defining a transition region 14 that is at least partially surrounded by an impingement sleeve 16 disposed radially outwardly of the transition piece 12. Upstream thereof, proximate a forward end 18 of the impingement sleeve 16 is a combustor liner 20 defining a combustor chamber 22. The combustor liner 20 is at least partially surrounded by a flow sleeve 24 disposed radially outwardly of the combustor liner 20. A forward sleeve 26 is located at the junction between the forward end 18 of the impingement sleeve 16 and an aft end 28 of the flow sleeve 24.

Although the combustor liner 20 and the transition piece 12 are described above and illustrated as being distinct, separate components, it is to be appreciated that a single, integrated liner may define the combustor chamber 22 and the transition region 14. In such an embodiment, a single sleeve may be employed to surround the liner, rather than two separate sleeves, such as the flow sleeve 24 and the impingement sleeve 16 described above.

The combustor section 10 uses a combustible liquid and/or gas fuel, such as a natural gas or a hydrogen rich synthetic gas, to run the gas turbine system. The combustor chamber 22 is configured to receive and/or provide an air-fuel mixture, thereby causing a combustion that creates a hot pressurized gas through the transition piece 12 into the turbine section (not illustrated), causing rotation of the turbine section. The presence of the hot pressurized gas increases the temperature of the combustor liner 20 surrounding the combustor chamber 22, particularly proximate a downstream end 30 of the combustor liner 20. To overcome issues associated with excessive thermal exposure to the combustor liner 20, a plurality of apertures 32 within the flow sleeve 24 are arranged to provide impinged air in the form of a plurality of cooling jets onto the combustor liner 20. A cross-flow 36 flows relatively perpendicularly to the plurality of cooling jets. Specifically, the cross-flow 36 flows from a region defined by the impingement sleeve 16 and the transition region 14 to a region defined by the flow sleeve 24 and the combustor liner 20.

Referring now to FIG. 2, an enlarged view of the region defined by the flow sleeve 24 and the combustor liner 20 is shown in greater detail. Although the following description is made with reference to the region defined by the flow sleeve 24 and the combustor liner 20, as noted above, it is contemplated that exemplary embodiments relate to the region defined by the impingement sleeve 16 and the transition piece 12. Yet other embodiments include a region defined by a single sleeve and a single, integrated liner defining the transition region 14 and the combustor chamber 22.

Disposed within an annular channel 38 defined by the flow sleeve 24 and the combustor liner 20 is a cooling jacket 40 that includes a body portion 42 extending circumferentially around at least a portion of an outer surface 44 of the combustor liner 20, which also includes an inner surface 45. The body portion 42 includes a body portion inner surface 46 and a body portion outer surface 48. At least one, but typically a plurality of support members 50 are disposed between the body portion 42 of the cooling jacket 40 and the outer surface 44 of the combustor liner 20. Each of the plurality of support members 50 are operably connected to the cooling jacket 40 and typically are integrally formed with the cooling jacket 40. The plurality of support members 50 are also typically operably connected to the combustor liner 20, with the operable connection comprising any suitable fastening structure, such as a mechanical fastener or a weld, for example. Additionally, in one embodiment, the cooling jacket 40 is integrally formed with the combustor liner 20 by a fixed connection between the plurality of support members 50 and the combustor liner 20.

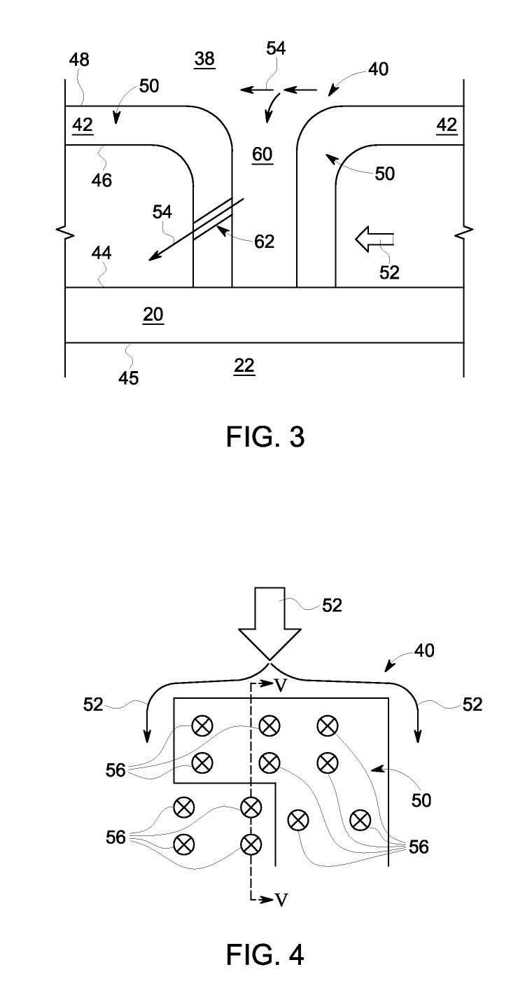

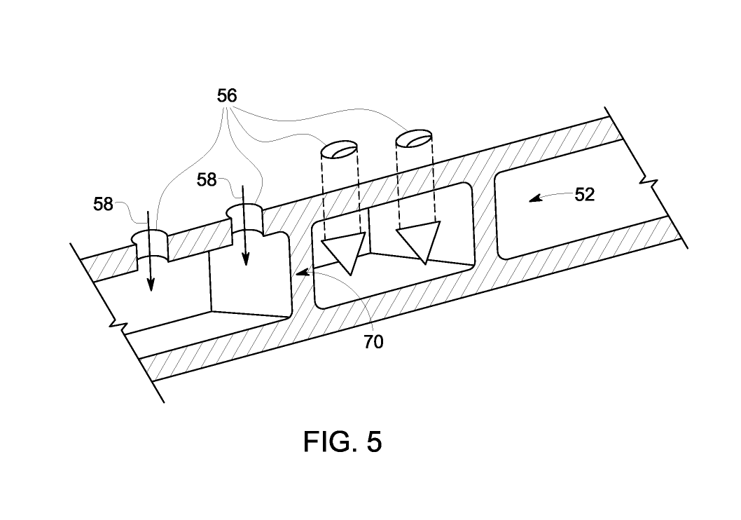

The plurality of support members 50 may be formed in various geometric configurations, with an exemplary geometric configuration comprising an airfoil-shaped member that is configured to interact with a first cooling flow 52 that is split from a second cooling flow 54. The first cooling flow 52 is directed between the cooling jacket 40 and the combustor liner 20, while the second cooling flow 54 is directed between the cooling jacket 40 and the flow sleeve 24. It is also contemplated that the plurality of support members 50 may be of various alternative geometries, such as a cylindrical member, for example. Irrespective of the precise geometric configuration, the plurality of support members 50 may be disposed in numerous arrangements. Typically, the plurality of support members 50 are disposed at a plurality of axial locations and circumferentially spaced from one another. The plurality of support members 50 can be used to reduce the cross flow effects from the first cooling flow 52. The plurality of support members 50 can be more sophisticated, as will be discussed below with reference to FIG. 3 or simply a wall-like structure as shown in FIG. 5.

The cooling jacket 40 includes at least one, but typically a plurality of apertures 56 extending through the body portion 42 of the cooling jacket 40. The plurality of apertures 56 provide additional impinged air in the form of convective cooling streams 58 that are in close proximity to the outer surface 44 of the combustor liner 20, thereby enhancing the convective cooling of the combustor liner 20.

Referring now to FIGS. 3 and 4, enlarged views of the annular channel 38, as well as the combustor liner 20 and the cooling jacket 40, are shown in greater detail. As illustrated, one or more of the plurality of support members 50 may include a hollow portion 60 configured to receive a portion of the second cooling flow 54. Injection of the second cooling flow 54 into the hollow portion 60 of the plurality of support members 50 provides a cooling effect on the plurality of support members 50, which conductively cools the combustor liner 20 to which the plurality of support members 50 are operably connected to. The portion of the second cooling flow 54 that is circulated within the plurality of support members 50 may be expelled through a hole 62 extending from the hollow portion 60 to the annular channel 38. Furthermore, the hole 62 may be aligned to expel the second cooling flow 54 toward the outer surface 44 of the combustor liner 20, which enhances the convective cooling effect that is already provided by the plurality of apertures 56 disposed within the body portion 42 of the cooling jacket 40.

The plurality of support members 50 may be arranged in a staggered arrangement to form a torturous path for the first cooling flow 52 to flow through. Such an arrangement includes positioning portions of the plurality of support members 50 in relative circumferential alignment with at least one of the plurality of apertures 56 disposed in the body portion 42 of the cooling jacket 40, thereby diverting the first cooling flow 52 to reduce a disturbance of the convective cooling streams 58 generated by the plurality of apertures 56. The convective cooling streams 58 more efficiently cool targeted locations of the combustor liner 20. Additionally, the diversion of the first cooling flow 52 increases the average velocity of the first cooling flow 52, which increases the convective heat transfer associated with the flowing of the first cooling flow 52 over the combustor liner 20.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A liner cooling assembly for a gas turbine system comprising:
a liner having an outer surface and an inner surface, the inner surface defining an interior region;
a sleeve disposed radially outwardly of the outer surface of the liner, the sleeve and the outer surface of the liner defining a channel configured to receive a cooling flow; and
a cooling jacket extending circumferentially around at least a portion of the outer surface of the liner and disposed between the liner and the sleeve, wherein the cooling jacket comprises at least one support operably coupled to the cooling jacket and the outer surface of the liner.

2. The liner cooling assembly of claim 1, wherein the cooling jacket further comprises at least one aperture configured to impinge the cooling flow on the outer surface of the liner.

3. The liner cooling assembly of claim 1, wherein the at least one support comprises an airfoil geometry.

4. The liner cooling assembly of claim 1, wherein the at least one support is relatively hollow for receiving a support airflow therein.

5. The liner cooling assembly of claim 1, further comprising a plurality of supports disposed at a plurality of axial locations and arranged in a circumferentially staggered configuration.

6. The liner cooling assembly of claim 1, wherein the liner comprises a combustor liner defining a combustor chamber.

7. The liner cooling assembly of claim 6, wherein the sleeve comprises a flow sleeve surrounding at least a portion of the combustor liner.

8. The liner cooling assembly of claim 1, wherein the liner comprises a transition piece liner defining a transition region.

9. The liner cooling assembly of claim 8, wherein the sleeve comprises an impingement sleeve surrounding at least a portion of the transition piece liner.

10. The liner cooling assembly of claim 1, wherein the liner is a unitary member and defines a combustor chamber and a transition region.

11. A combustor liner cooling assembly for a gas turbine system comprising:
a combustor liner defining a combustor chamber;
a flow sleeve surrounding at least a portion of the combustor liner, the flow sleeve and the combustor liner defining a channel configured to receive a cooling flow; and
a cooling jacket surrounding at least a portion of the combustor liner and disposed between the combustor liner and the flow sleeve, wherein the cooling jacket comprises at least one support extending radially inwardly from the cooling jacket toward the combustor liner.

12. The combustor liner cooling assembly of claim 11, wherein the cooling jacket further comprises at least one aperture configured to impinge the cooling flow on the combustor liner.

13. The combustor liner cooling assembly of claim 11, wherein the at least one support comprises an airfoil geometry.

14. The combustor liner cooling assembly of claim 11, wherein the at least one support is relatively hollow for receiving a support airflow therein.

15. The combustor liner cooling assembly of claim 11, further comprising a plurality of supports disposed at a plurality of axial locations and arranged in a circumferentially staggered configuration.

16. The combustor liner cooling assembly of claim 11, wherein the at least one support is fixedly connected to the flow sleeve and the combustor liner.

17. A combustor liner cooling assembly for a gas turbine system comprising:
a combustor liner defining a combustor chamber;
a flow sleeve surrounding at least a portion of the combustor liner, the flow sleeve and the combustor liner defining a channel configured to receive a cooling flow; and
a cooling jacket integrally formed with the combustor liner, wherein the cooling jacket comprises:
a body portion disposed radially outwardly of the combustor liner;
a plurality of support members fixedly connected to an inner surface of the body portion and an outer surface of the combustor liner; and
a plurality of apertures extending through the body portion of the cooling jacket.

18. The combustor liner cooling assembly of claim 17, wherein each of the plurality of support members comprise an airfoil geometry.

19. The combustor liner cooling assembly of claim 17, wherein each of the plurality of support members are relatively hollow for receiving a support airflow therein.

20. The combustor liner cooling assembly of claim 17, wherein the plurality of support members are disposed at a plurality of axial locations and arranged in a circumferentially staggered configuration.
